(19) United States
(12) Patent Application Publication
(10) Pub. No.: US 2024/0072982 A1
(43) Pub. Date: Feb. 29, 2024

(54) SEPARATE IMPLICIT UPDATE OF ACTIVATED TRANSMISSION CONFIGURATION INDICATOR STATES FOR DOWNLINK AND UPLINK

(71) Applicant: Telefonaktiebolaget LM Ericsson (publ), Stockholm (SE)

(72) Inventors: Claes TIDESTAV, Bålsta (SE); Andreas NILSSON, Göteborg (SE); Helka-Liina MÄÄTTÄNEN, Helsinki (FI); Siva MURUGANATHAN, Stittsville (CA)

(21) Appl. No.: 18/259,703

(22) PCT Filed: Dec. 29, 2021
(86) PCT No.: PCT/SE2021/051319

§ 371 Date: Jun. 28, 2023

Related U.S. Application Data
(60) Provisional application No. 63/132,040, filed on Dec. 30, 2020.

(51) Int. Cl. H04L 5/00; H04B 7/06

(52) U.S. Cl. CPC H04L 5/0096; H04B 7/0695

(57) ABSTRACT

A method, system and apparatus for separate implicit update of activated transmission configuration indicator (TCI) states for downlink (DL) and uplink (UL) are disclosed. According to one aspect, a method in a wireless device (WD) includes sending a measurement report for at least one reference signal to a network node, the at least one reference signal being related to at least one TCI state, the at least one TCI state being at least one of a DL TCI state and an UL TCI state. The method also includes activating at least one TCI state that is related to the at least one reference signal.

### TECHNICAL FIELD

The present disclosure relates to wireless communications, and in particular, to separate implicit update of activated transmission configuration indicator (TCI) states for downlink (DL) and uplink (UL) wireless communications.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

In NR, several signals can be transmitted from different antenna ports of a same base station (gNB). These signals can have the same large-scale properties such as Doppler shift or spread, average delay spread, or average delay. These antenna ports are then said to be quasi co-located (QCL).

If the WD knows that two antenna ports are QCL with respect to a certain parameter (e.g., Doppler spread), the WD can estimate that parameter based on one of the antenna ports and apply that estimate for receiving signals on the other antenna port.

For example, there may be a QCL relation between a CSI-RS for a tracking reference signal (TRS) and the physical downlink shared channel (PDSCH) demodulation reference signal (DMRS). Then the WD can use the measurements already made on the TRS to assist the DMRS reception.

Information about what assumptions can be made regarding QCL is signaled to the WD from the network. In NR, four types of QCL relations between a transmitted source RS and transmitted target RS are defined, including:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced to facilitate beam management with analog beamforming and is known as spatial QCL. There is currently no strict definition of spatial QCL, but the understanding is that if two transmitted antenna ports are spatially QCL, the WD can use the same receive (RX) beam to receive them. This is helpful for a WD that uses analog beamforming to receive signals, since the WD needs to adjust its RX beam in some direction prior to receiving a certain signal. If the WD knows that the signal is spatially QCL with some other signal it has received earlier, then the WD can safely use the same RX beam to receive this signal, also. Note that for beam management, it is also necessary to convey a Type A QCL relation for the RSs to the WD, so that the WD can estimate all the relevant large-scale parameters.

Typically, this is achieved by configuring the WD with a CSI-RS for tracking (a tracking reference signal, TRS) and time/frequency offset estimation. To be able to use any QCL reference, the WD would have to receive the QCL reference with a sufficiently good signal to interference plus noise ratio (SINR). In many cases, this means that the TRS must be transmitted in a suitable beam to a certain WD

To introduce dynamics in beam and transmission point (TRP) selection, the WD can be configured through radio resource control (RRC) signaling with up to 128 TCI (Transmission Configuration Indicator) states. An example of the TCI state information element (IE) is shown in the following code:

| | |
|---|---|
| TCI-State ::= | SEQUENCE { |
| tci-StateId | TCI-StateId, |
| qcl-Type1 | QCL-Info, |
| qcl-Type2 | QCL-Info |
| . . . | |
| } | |
| QCL-Info ::= | SEQUENCE |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| . . . | |
| } | |

Each TCI state contains QCL information related to one or two reference signals (RSs). For example, a TCI state may contain CSI-RS1 associated with QCL Type A and CSI-RS2 associated with QCL TypeD. If a third RS, such as a demodulation reference signal (DMRS) on the physical downlink control channel (PDCCH), has this TCI state as QCL source, then the WD can derive Doppler shift, Doppler spread, average delay, delay spread from CSI-RS1 and the Spatial RX parameter (i.e., the receive beam to use) from CSI-RS2 when performing the channel estimation for the PDCCH DMRS.

A first list of available TCI states is configured for the PDSCH, and a second list of TCI states is configured for the PDCCH. Each TCI state contains a pointer, known as TCI State ID, which points to the TCI state. The network node (base station, gNB) then activates, via a medium access control (MAC) control element (CE), one TCI state for the PDCCH (i.e., provides a TCI for PDCCH) and up to eight TCI states for the PDSCH. The number of active TCI states the WD can support is a WD capability, but the maximum is 8.

Assume that a WD has 4 activated TCI states from a list of 64 total configured TCI states. Then there are 60 TCI states that are inactive for this particular WD and the WD need not be prepared to have large scale parameters estimated for those inactive TCI states. But the WD continuously tracks and updates the large scale parameters for the reference signals in the 4 active TCI states. When scheduling a PDSCH to a WD, the downlink control information (DCI) contains a pointer to one activated TCI state. The WD then knows which large scale parameter estimate to use when performing PDSCH DIVERS channel estimation and thus, PDSCH demodulation.

As long as the WD can use any of the currently activated TCI states, it is sufficient to use DCI signaling. However, at some point in time, there may be a situation where none of the reference signals in the currently activated TCI states can be received by the WD, i.e., when the WD moves out of the beams in which the reference signals in the activated TCI states are transmitted. When this happens, or before this happens, the network node will have to activate new TCI states. Typically, since the number of activated TCI states is fixed, the network node will also have to deactivate one or more of the currently activated TCI states. Base stations, such as eNBs and gNBs, are referred to herein as network nodes.

A two-step procedure related to TCI state update is depicted in FIG. 1.

TCI states Activation/Deactivation for WD-specific PDSCH via MAC CE

The details of the MAC CE signaling that is used to activate and deactivate TCI states for WD specific PDSCH are disclosed herein. The structure of the MAC CE for activating and deactivating TCI states for WD specific PDSCH is given in FIG. 2.

As shown in FIG. 2, the MAC CE may contain the following fields:
Serving Cell ID: This field indicates the identity of the Serving Cell for which the MAC CE applies. The length of the field is 5 bits;
Bandwidth part (BWP) ID: This field contains the ID corresponding to a downlink bandwidth part for which the MAC CE applies. The BWP ID is given by the higher layer parameter BWP-Id as specified in the 3GPP Technical Standard (3GPP TS) 38.331. The length of the BWP ID field is 2 bits since a WD can be configured with up to 4 bandwidth parts (BWPs) for DL;
A variable number of fields Tᵢ: If the WD is configured with a TCI state with TCI State ID i, then the field Tᵢ indicates the activation/deactivation status of the TCI state with TCI State ID i. If the WD is not configured with a TCI state with TCI State ID i, the MAC entity should ignore the Tᵢ field. The Tᵢ field is set to “1” to indicate that the TCI state with TCI State ID i is to be activated and mapped to the codepoint of the DCI Transmission Configuration Indication field, as specified in 3GPP TS 38.214. The Tᵢ field is set to “0” to indicate that the TCI state with TCI State ID i is to be deactivated and is not mapped to the codepoint of the DCI Transmission Configuration Indication field. It should be noted that the codepoint to which the TCI State is mapped is determined by the ordinal position among all the TCI States with Tᵢ field set to “1”. That is, the first TCI State with Tᵢ field set to “1” is to be mapped to the codepoint value 0 of DCI Transmission Configuration Indication field, the second TCI State with Tᵢ field set to “1” is to be mapped to the codepoint value 1 of DCI Transmission Configuration Indication field, and so on. In 3GPP NR Release (Rel)-15, the maximum number of activated TCI states is 8; and
A Reserved bit R: this bit is set to ‘0’ in 3GPP NR Rel-15.

Note that activation and deactivation for WD-specific PDSCH MAC CE is identified by a MAC packet data unit (PDU) subheader with logical channel ID (LCID) as specified in Table 6.2.1-1 of 3GPP TS 38.321. The MAC CE for activation and deactivation of TCI States for WD-specific PDSCH has variable size.

TCI State Indication for WD-Specific PDSCH Via DCI

The network node can use DCI format 11 or 12 to indicate to the WD that it shall use one of the activated TCI states for the subsequent PDSCH reception. The field being used in the DCI is transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 3.

DCI code point 0 indicates the first TCI state index in the list of TCI states, DCI code point 1 indicates the second TCI state index in the list, and so on.

MAC CE Activation and DCI Indication

A similar mechanism as described above is also being defined for associating the spatial relation of the physical uplink control channel (PUCCH), sounding reference signal (SRS), where a MAC Control element is defined representing the activated spatial relation, where the number of spatial relations corresponding to the number of bits used in DCI. For the PUCCH, in DCI formats 1-0/1-1, the “PUCCH Resource Indicator” field is 3 bits. In 3GPP Release 15 (Rel-15), a MAC CE (given in clause 6.1.3.18 of 3GPP TS 38.321 V16.2.1) provides the spatial relation for each physical uplink control channel (PUCCH) resource. The MAC CE contains a ‘PUCCH Resource ID’ field with 7 bits, and one out of 8 spatial relation information elements to the PUCCH resource with the given ‘PUCCH Resource ID’. The field size of 7 bits for the TUCCH Resource ID′ field is derived from the maxNrofPUCCH-Resources which is 128.

3GPP Rel-17 TCI State Framework

In 3GPP Rel-17, a new enhanced TCI state framework is expected to be specified. It was considered that the new TCI state framework should include a three stage TCI state indication in a similar way as was described above for the PDSCH. The three stage TCI state indication may be for all or a subset of all DL and/or UL channels and signals. In the first stage, radio resource control (RRC) is used to configure a pool of TCI states. In the second stage, one or more of the RRC configured TCI states are activated via MAC-CE signaling. Finally, in the third stage, DCI signaling is used to select one of the TCI states that was activated via MAC-CE. The TCI states used for DL and UL channels and signals can either be taken from the same pool of TCI states or from separate pools of TCI states (i.e., from separate DL TCI state and UL TCI state pools). It is also possible that two separate list of activated TCI states are used, one for DL channels and signals and one for UL channels and signals.

Some issues considered are as follows:

On a beam indication signaling medium to support joint or separate DL/UL beam indication in 3GPP Rel-17 unified TCI framework:
Support L1-based beam indication using at least WD-specific (unicast) DCI to indicate joint or separate DL/UL beam indication from the active TCI states;
a) The existing DCI formats 1_1 and 1_2 are reused for beam indication;
Support activation of one or more TCI states via MAC CE analogous to 3GPP Re1.15/16.

On a 3GPP Release 17 (Rel-17) unified TCI framework, to accommodate the case of separate beam indication for UL and DL:
Utilize two separate TCI states, one for DL and one for UL;
For the separate DL TCI:
a) The source reference signal(s) in M TCIs provide QCL information at least for WD-dedicated reception on PDSCH and for WD-dedicated reception on all or subset of CORESETs in a CC;
For the separate UL TCI:
a) The source reference signal(s) in N TCIs provide a reference for determining common UL transmit (TX) spatial filter(s) at least for dynamic-grant/configured-grant based

PUSCH, all or subset of dedicated PUCCH resources in a CC;
b) Optionally, this UL TX spatial filter can also apply to all SRS resources in resource set(s) configured for antenna switching/codebook-based/non-codebook-based UL transmissions; and
Whether the UL TCI state is taken from a common/same or separate TCI state pool from DL TCI state was left for further study by the 3GPP.

Maximum Permissible Exposure (MPE) issue and UL beam reporting

In 3GPP standards development, two methods have been introduced to enable the WD to comply with regulatory exposure limits; reduced maximum output power (referred to as P-MPR) and reduced UL transmission duty cycle.

For frequency range 2 (FR2), maxUplinkDutyCycle-FR2 is a WD capability and indicates the maximum percentage of symbols during one second that can be scheduled for uplink transmission in order to comply with regulatory exposure limits.

In cases where the field of WD capability maxUplinkDutyCycle-FR2 is not present or is present but the percentage of uplink symbols transmitted within any one second evaluation period is larger than marUplinkDutyCycle-FR2, the WD can apply power management maximum power reduction (P-MPR) to meet the regulatory exposure limits. By applying P-MPR, the WD can reduce the maximum output power for a WD power class with x number of dB (where the range of x is still being considered in by the 3GPP). For example, for WD power class 2 with a P-MPR value x=10 dB, the WD is allowed to reduce the maximum output power (Pcmax) from 23 dBm to 13 dBm (23 dBm−10 dB=13 dBm). Due to P-MPR and maxUplinkDutyCycle-FR2, the maximum uplink performance of a selected UL transmission path can be significantly deteriorated.

Since MPE issues may be highly directional in FR2, the required P-MPR and maxUplinkDutyCycle would be uplink beam specific and would very likely be different among different candidate uplink beams across different WD antenna panels. That means that certain beams or panels, e.g., ones that may be pointing towards a human body, may have potentially very high required P-MPR/low duty cycle while some other beams or panels, i.e., ones of which beam pattern may not coincide with a human body, may have very low required P-MPR/high duty cycle.

Due to maximum permissible exposure (MPE) issues, different power amplifier (PA) architectures per WD panel and/or different available UL output power per panel may be employed depending on the generated beam width. For example, in commercial WDs, wider beams at a WD panel are generated by turning off one or more antenna elements and corresponding PAs which will reduce the available maximum UL output power for that panel. The available maximum UL output power may differ between different WD panels and WD beams.

In 3GPP NR Rel-16, it is only possible to configure the WD to report Layer 1 (L1) reference signal received power (RSRP) (or L1 signal to interference plus noise ratio (SINR)) based on DL measurements for the N best network node beams during a network node beam sweep, which means that the network node will not get full information about how well the beam pair link associated with the N best DL-RS included in the beam report will work for UL transmissions. A few solutions to this problem have been described, where a separate beam report based on UL performance was signaled from the WD to the transmission point (TRP), or where UL related performance per beam is included in a DL performance based beam report. In this way, the network node can determine which beam pair link to use for UL and/or DL

Support for DCI based beam indication for joint or separate DL/UL beam from the active TCI states using a three stage TCI state indication approach has been considered. The three stage TCI state indication approach may still involve activation/indication delay due to the involvement of RRC, MAC CE and DCI. This may not be suitable for certain applications involving WDs that move at very high speeds. Implicit updating of TCI state can significantly reduce the TCI update, activation and/or indication time.

A method for implicitly updating the activated TCI state(s) is known. However, this method was only applied to the case where a WD is configured with a single list of activated TCI states used for DL signals/channels and where the activated TCI states is updated implicitly based on DL performance measurements.

### SUMMARY

Some embodiments advantageously provide methods, systems, and apparatuses for separate implicit update of activated transmission configuration indicator (TCI) states for downlink (DL) and uplink (UL).

Based on a beam report (signaled from the WD to the network node), one or more of the activated DL and/or activated UL TCI states for a WD are implicitly updated. Depending on the configuration of the beam report, only an activated DL TCI state is updated, or only an activated UL TCI state is updated or both an activated DL TCI state and an activated UL TCI state are updated

Some embodiments enable faster TCI state activation for a WD compared to known methods. In some embodiments, the WD is configured with two separate lists of activated TCI states, one list with DL TCI states, and one list with UL TCI states.

According to one aspect, a network node configured to communicate with a wireless device (WD). The network node includes a radio interface configured to receive a beam report from the WD. The beam report includes at least one indication of a transmission configuration indicator (TCI) state, an indication indicating one of: a downlink (DL) TCI state; an uplink (UL) TCI state; and both the DL TCI state and the UL TCI state. The network node also includes processing circuitry in communication with the radio interface. The processing circuitry is configured to configure at least one codepoint based at least in part on at least one of the at least one indication included in the beam report. Each codepoint is configured to implicitly indicate one of: the updated DL TCI state; the updated UL TCI state; and both the updated DL TCI state and the updated UL TCI state. The radio interface is further configured to transmit the at least one codepoint to the WD.

According to this aspect, in some embodiments, only an updated DL TCI state is indicated by at least one of the at least one codepoint based on an indication of DL performance. In some embodiments, only an updated UL TCI state is indicated by at least one of the at least one codepoint based on an indication of UL performance. In some embodiments, a first codepoint is configured for DL TCI states and a second codepoint is configured for UL TCI states. In some embodiments, each of a plurality of codepoints are configured to implicitly indicate a different one of a set of at least one of DL TCI states and UL TCI states. In some embodiments, each of the at least one codepoint is configured by one of a medium access control (MAC) control element (CE) and downlink control information (DCI).

According to another aspect, a method in a network node configured to communicate with a WD is provided. The method includes receiving a beam report from the WD. The beam report includes at least one indication of a TCI state, an indication indicating one of: a DL TCI state; an UL TCI state; and both the DL TCI state and the UL TCI state; and configuring at least one codepoint based at least in part on at least one of the at least one indication included in the beam report. Each codepoint is configured to implicitly indicate one of: the updated DL TCI state; the updated UL TCI state; and both the updated DL TCI state and the updated UL TCI state. The method also includes transmitting the at least one codepoint to the WD.

According to this aspect, in some embodiments, only an updated DL TCI state is indicated by at least one of the at least one codepoint based on an indication of DL performance. In some embodiments, only an updated UL TCI state is indicated by at least one of the at least one codepoint based on an indication of UL performance. In some embodiments, a first codepoint is configured for DL TCI states and a second codepoint is configured for UL TCI states. In some embodiments, each of a plurality of codepoints are configured to implicitly indicate a different one of a set of at least one of DL TCI states and UL TCI states. In some embodiments, each of the at least one codepoint for a plurality of TCI states are configured by one of a MAC CE and DCI.

According to yet another aspect, a wireless device, WD, configured to communicate with a network node. The WD includes a radio interface configured to transmit a beam report to the network node. The beam report includes at least one codepoint indicating a transmission configuration indicator, TCI, state for at least one of: a downlink, DL, beam; an uplink, UL, beam; and both the DL beam and the UL beam.

According to this aspect, in some embodiments, the TCI state for a DL beam is indicated based only on a DL performance measurement. In some embodiments, the TCI state for an UL beam is indicated based only on an UL performance measurement. In some embodiments, a first codepoint indicates a TCI state for a DL beam and a second codepoint indicates a TCI state for an uplink beam. In some embodiments, the at least one codepoint indicates a TCI state for one of a DL beam determined to provide a best DL performance of a plurality of DL beams and an UL beam determined to provide a best UL performance of a plurality of UL beams. In some embodiments, a subset of a plurality of codepoints are configured for implicit indication of TCI states. In some embodiments, the beam report further includes a list of a plurality of beams in order of highest performance to lowest performance.

According to another aspect, a method in a WD configured to communicate with a network node is provided. The method includes transmitting a beam report to the network node. The beam report includes at least one codepoint indicating a TCI state for at least one of: a downlink beam; an uplink beam; and both the DL beam and the UL beam.

According to this aspect, in some embodiments, the TCI state for a DL beam is indicated based only on a DL performance measurement. In some embodiments, the TCI state for an UL beam is indicated based only on an UL performance measurement. In some embodiments, a first codepoint indicates a TCI state for a DL beam and a second codepoint indicates a TCI state for an uplink beam. In some embodiments, the at least one codepoint indicates a TCI state for one of a DL beam determined to provide a best DL performance of a plurality of DL beams and an UL beam determined to provide a best UL performance of a plurality of UL beams. In some embodiments, a subset of a plurality of codepoints are configured for implicit indication of TCI states. In some embodiments, the beam report further includes a list of a plurality of beams in order of highest performance to lowest performance.

According to another aspect, a method performed by a WD for implicitly indicating at least one of DL and UL TCI state activation is provided. The method includes sending a measurement report for at least one reference signal to a network node, the at least one reference signal being related to at least one TCI state, the at least one TCI state being at least one of a DL TCI state and an UL TCI state. The method includes activating at least one TCI state that is related to the at least one reference signal.

According to this aspect, in some embodiments, a DL TCI state is activated when a beam report includes an DL performance metric. In some embodiments, the DL performance metric includes at least one of DL reference signal received power (RSRP) and DL signal to interference plus noise ratio (SINR). In some embodiments, an UL TCI state is activated when a beam report includes an UL performance metric. In some embodiments, the UL performance metric includes at least one of UL reference signal received power, RSRP, virtual power head room, power head room, DL-RSRP+reduced maximum output power (P-MPR) and P-MPR. In some embodiments, a TCI state is not activated unless the network node sends an acknowledgment, either via MAC CE or DCI. In some embodiments, at least one of a list of activated DL TCI states and a list of activated UL TCI states configured for the WD by the network node includes a number, M1, of entries that are reserved for implicit DL TCI state activation. In some embodiments, at least one of a list of activated DL TCI states and a list of activated UL TCI states configured for the WD by the network node includes a number, M2, of entries that are reserved for implicit UL TCI state activation. In some embodiments, at least one of a list of activated DL TCI states and a list of activated UL TCI states configured for the WD by the network node includes a number, M3, of entries that are reserved for implicit DL TCI state activation and UL TCI state activation. In some embodiments, at least one of a list of activated DL TCI states and a list of activated UL TCI states configured for the WD by the network node includes a number, N1, of entries that are reserved for explicit DL TCI state activation. In some embodiments, at least one of a list of activated DL TCI states and a list of activated UL TCI states configured for the WD by the network node includes a number, N2, of entries that are reserved for explicit UL TCI state activation. In some embodiments, at least one of a list of activated DL TCI states and a list of activated UL TCI states configured for the WD by the network node includes a number, N3, of entries that are reserved for explicit DL TCI state activation and explicit UL TCI state activation.

According to yet another aspect, a WD configured to implicitly indicate at least one of DL and UL TCI state activation is provided. The WD includes a radio interface configured to send a measurement report for at least one reference signal to a network node, the at least one reference signal being related to at least one TCI state, the at least one TCI state being at least one of a DL TCI state and an UL TCI state. The WD also includes processing circuitry in communication with the radio interface and configured to activate at least one TCI state that is related to the at least one reference signal.

According to this aspect, in some embodiments, a DL TCI state is activated when a beam report includes an DL performance metric. In some embodiments, the DL performance metric includes at least one of DL RSRP and DL SINR. In some embodiments, an UL TCI state is activated when a beam report includes an UL performance metric. In some embodiments, the UL performance metric includes at least one of UL RSRP, virtual power head room, power head room, DL-RSRP+reduced maximum output power (P-MPR) and P-MPR. In some embodiments, a TCI state is not activated unless the network node sends an acknowledgment, either via MAC CE or DCI. In some embodiments, at least one of a list of activated DL TCI states and a list of activated UL TCI states configured for the WD by the network node includes a number, M1, of entries that are reserved for implicit DL TCI state activation. In some embodiments, at least one of a list of activated DL TCI states and a list of activated UL TCI states configured for the WD by the network node includes a number, M2, of entries that are reserved for implicit UL TCI state activation. In some embodiments, at least one of a list of activated DL TCI states and a list of activated UL TCI states configured for the WD by the network node includes a number, M3, of entries that are reserved for implicit DL TCI state activation and UL TCI state activation. In some embodiments, at least one of a list of activated DL TCI states and a list of activated UL TCI states configured for the WD by the network node includes a number, N1, of entries that are reserved for explicit DL TCI state activation. In some embodiments, at least one of a list of activated DL TCI states and a list of activated UL TCI states configured for the WD by the network node includes a number, N2, of entries that are reserved for explicit UL TCI state activation. In some embodiments, at least one of a list of activated DL TCI states and a list of activated UL TCI states configured for the WD by the network node includes a number, N3, of entries that are reserved for explicit DL TCI state activation and explicit UL TCI state activation.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a flowchart of a process related to transmission configuration indicator (TCI) state updates;

FIG. 2 is an example structure of a medium access control (MAC) control elements (CE) for activating/deactivating TCI states for wireless device (WD) specific physical downlink shared channel (PDSCH);

FIG. 3 is an example of a downlink control information (DCI) indication;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for separate implicit update of activated TCI states for downlink (DL) and uplink (UL); and

FIG. 11 is a flowchart of an example process in a WD for separate implicit update of activated TCI states for DL and UL;

FIG. 12 is a flowchart of another example process in a network node for separate implicit update of activated TCI states for DL and UL;

FIG. 13 is a flowchart of another example process in a WD for separate implicit update of activated TCI states for DL and UL;

FIG. 14 is a flowchart of yet another example process in a WD for separate implicit update of activated TCI states for DL and UL

FIG. 15 illustrates association of DL and UL TCI states for different codepoints;

FIG. 16 illustrates each codepoint being associated with an uplink TCI state;

FIG. 17 illustrates a codepoint explicitly configured to implicitly update one or both of DL TCI state and an UL TCI state;

FIG. 18 illustrates updating an integer number N of DL TCI states implicitly when N DL beams based on DL performance measurements are reported in a beam report;

FIG. 19 illustrates a beam report that reports the two best DL beams based on DL RSRP and two best UL beams based on UL reference signal received power (RSRP);

FIG. 20 illustrates two or more codepoints reserved for implicitly activated TCI states in the list of activated DL TCI states and/or the list of activated UL TCI states;

FIG. 21 illustrates a single report having a list of beams ordered only based on DL performance; and

FIG. 22 illustrates different synchronization signal blocks (SSBs) transmitted on different beams.

### DETAILED DESCRIPTION

Before describing in detail example embodiments, it is noted that the embodiments reside primarily in combinations of apparatus components and processing steps related to separate implicit update of activated transmission configuration indicator (TCI) states for downlink (DL) and uplink (UL). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

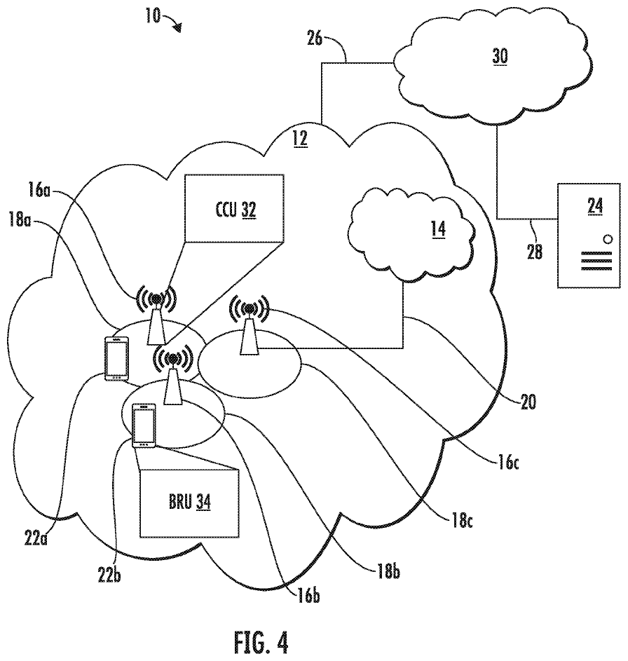

Some embodiments provide for separate implicit update of activated transmission configuration indicator (TCI) states for downlink (DL) and uplink (UL). Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NB s, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/Evolved Universal Terrestrial Radio Access Network (E-UTRAN) and a gNB for NR/Next Generation Radio Access Network (NG-RAN).

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

In some embodiments, a network node 16 is configured to include a codepoint configuration unit (CCU) 32 which is configured to configure a codepoint to update one or both of a downlink, DL, transmission configuration indicator, TCI, state and an uplink, UL, TCI state based on a beam report. In some embodiments, the CCU 32 is configured to configure at least one codepoint based at least in part on at least one of the at least one indication included in the beam report, each codepoint configured to implicitly indicate one of: the updated DL TCI state; the updated UL TCI state; and both the updated DL TCI state and the updated UL TCI state.

In some embodiments, a wireless device 22 is configured to include a beam report unit (BRU) 34 which is configured to transmit a beam report configured to report one or both of beams having a specified level of downlink, DL, performance and beams having a specified level of uplink, UL, performance. In some embodiments, the BRU 34 is configured to transmit a beam report to the network node, the beam report including at least one codepoint indicating a transmission configuration indicator, TCI, state for at least one of: a downlink, DL, beam; an uplink, UL, beam; and both the DL beam and the UL beam. In some embodiments, the radio interface 82 is configured to: send a measurement report for at least one reference signal to a network node, the at least one reference signal being related to at least one TCI state, the at least one TCI state being at least one of a downlink, DL, TCI state and an uplink, UL TCI state; and activate at least one TCI state that is related to the at least one reference signal.

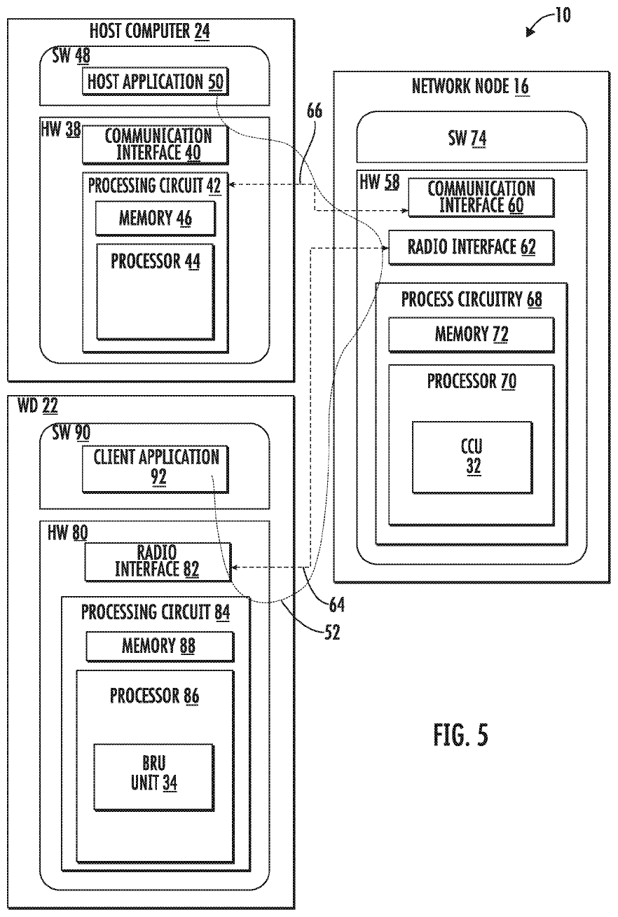

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include codepoint configuration unit (CCU) 32 which may be configured to configure a codepoint to update one or both of a downlink, DL, transmission configuration indicator, TCI, state and an uplink, UL, TCI state based on a beam report. In some embodiments, the CCU 32 is configured to configure at least one codepoint based at least in part on at least one of the at least one indication included in the beam report, each codepoint configured to implicitly indicate one of: the updated DL TCI state; the updated UL TCI state; and both the updated DL TCI state and the updated UL TCI state.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a beam report unit (BRU) 34 which may be configured to transmit a beam report configured to report one or both of beams having a specified level of downlink, DL, performance and beams having a specified level of uplink, UL, performance. In some embodiments, the BRU 34 is configured to transmit a beam report to the network node, the beam report including at least one codepoint indicating a transmission configuration indicator, TCI, state for at least one of: a downlink, DL, beam; an uplink, UL, beam; and both the DL beam and the UL beam. In some embodiments, the radio interface 82 is configured to: send a measurement report for at least one reference signal to a network node, the at least one reference signal being related to at least one TCI state, the at least one TCI state being at least one of a downlink, DL, TCI state and an uplink, UL TCI state; and activate at least one TCI state that is related to the at least one reference signal.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as CCU 32, and BRU 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

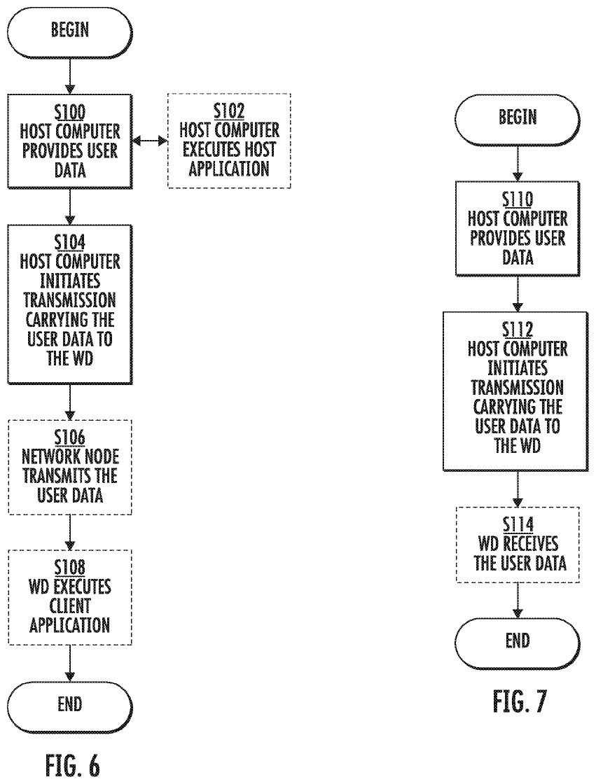

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

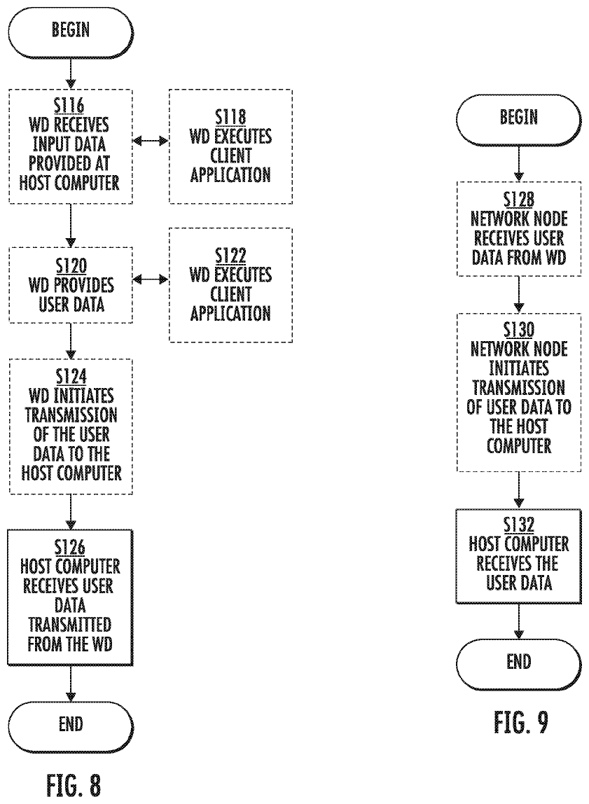

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

It is noted that references herein to the sending, transmission, etc., of a beam report generally refer to the sending, transmission, etc., of the beam report from a WD 22 to a network node 16.

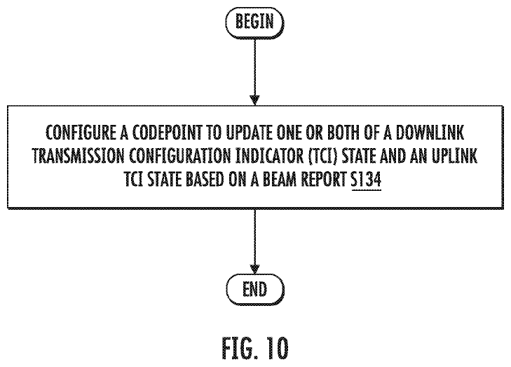

FIG. 10 is a flowchart of an example process in a network node 16 for separate implicit update of activated transmission configuration indicator (TCI) states for downlink (DL) and uplink (UL). One or more blocks described herein may be performed by one or more elements of network node 16 such as by one or more of processing circuitry 68 (including the codepoint configuration unit 32), processor 70, radio interface 62 and/or communication interface 60. Network node 16 such as via processing circuitry 68 and/or processor 70 and/or radio interface 62 and/or communication interface 60 is configured to configure a codepoint to update one or both of a downlink, DL, transmission configuration indicator, TCI, state and an uplink, UL, TCI state based on a beam report (Block S134).

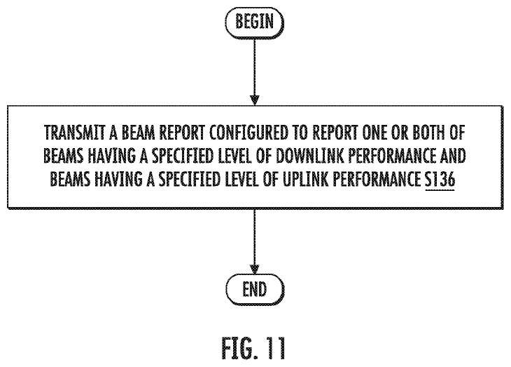

FIG. 11 is a flowchart of an example process in a wireless device 22 according to some embodiments of the present disclosure. One or more blocks described herein may be performed by one or more elements of wireless device 22 such as by one or more of processing circuitry 84 (including the beam report unit 34), processor 86, radio interface 82 and/or communication interface 60. Wireless device 22 such as via processing circuitry 84 and/or processor 86 and/or radio interface 82 is configured to transmit a beam report configured to report one or both of beams having a specified level of downlink, DL, performance and beams having a specified level of uplink, UL, performance (Block S136).

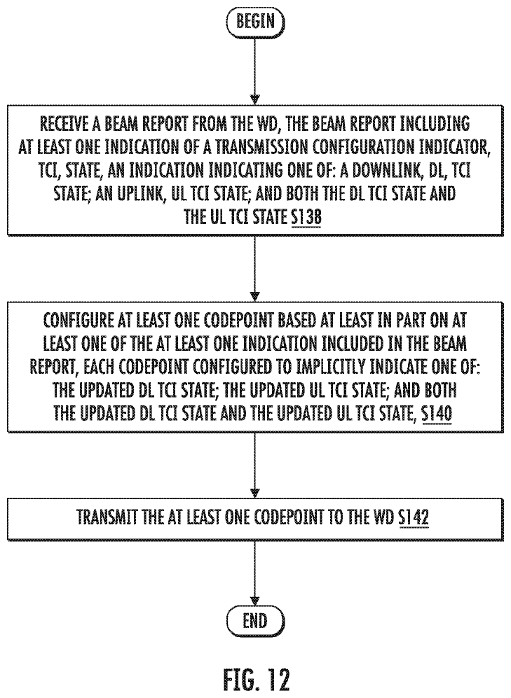

FIG. 12 is a flowchart of an another example process in a network node 16 for separate implicit update of activated transmission configuration indicator (TCI) states for downlink (DL) and uplink (UL). One or more blocks described herein may be performed by one or more elements of network node 16 such as by one or more of processing circuitry 68 (including the codepoint configuration unit 32), processor 70, radio interface 62 and/or communication interface 60. Network node 16 such as via processing circuitry 68 and/or processor 70 and/or radio interface 62 and/or communication interface 60 is configured to receive a beam report from the WD, the beam report including at least one indication of a transmission configuration indicator, TCI, state, an indication indicating one of: a downlink, DL, TCI state; an uplink, UL TCI state; and both the DL TCI state and the UL TCI state (Block S138). The process also includes configuring at least one codepoint based at least in part on at least one of the at least one indication included in the beam report, each codepoint configured to implicitly indicate one of: the updated DL TCI state; the updated UL TCI state; and both the updated DL TCI state and the updated UL TCI state (Block S140). The process further includes transmitting the at least one codepoint to the WD (Block S142).

In some embodiments, only an updated DL TCI state is indicated by at least one of the at least one codepoint based on an indication of DL performance. In some embodiments, only an updated UL TCI state is indicated by at least one of the at least one codepoint based on an indication of UL performance. In some embodiments, a first codepoint is configured for DL TCI states and a second codepoint is configured for UL TCI states. In some embodiments, each of a plurality of codepoints are configured to implicitly indicate a different one of a set of at least one of DL TCI states and UL TCI states. In some embodiments, each of the at least one codepoint for a plurality of TCI states are configured by one of a medium access control, MAC, control element, CE, and downlink control information.

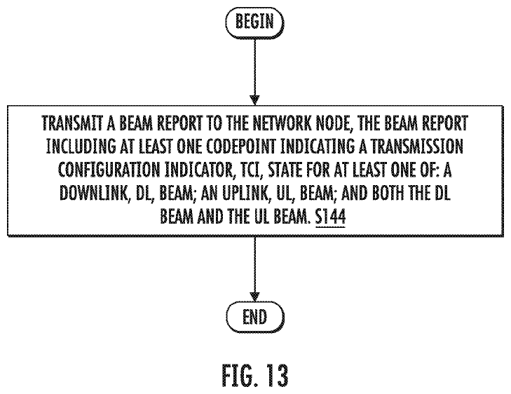

FIG. 13 is a flowchart of an example process in a wireless device 22 according to some embodiments of the present disclosure. One or more blocks described herein may be performed by one or more elements of wireless device 22 such as by one or more of processing circuitry 84 (including the beam report unit 34), processor 86, radio interface 82 and/or communication interface 60. Wireless device 22 such as via processing circuitry 84 and/or processor 86 and/or radio interface 82 is configured to transmit a beam report to the network node, the beam report including at least one codepoint indicating a transmission configuration indicator, TCI, state for at least one of: a downlink, DL, beam; an uplink, UL, beam; and both the DL beam and the UL beam (Block S144).

In some embodiments, the TCI state for a DL beam is indicated based only on a DL performance measurement. In some embodiments, the TCI state for an UL beam is indicated based only on an UL performance measurement. In some embodiments, a first codepoint indicates a TCI state for a DL beam and a second codepoint indicates a TCI state for an uplink beam. In some embodiments, the at least one codepoint indicates a TCI state for one of a DL beam determined to provide a best DL performance of a plurality of DL beams and an UL beam determined to provide a best UL performance of a plurality of UL beams. In some embodiments, a subset of a plurality of codepoints are configured for implicit indication of TCI states. In some embodiments, the beam report further includes a list of a plurality of beams in order of highest performance to lowest performance.

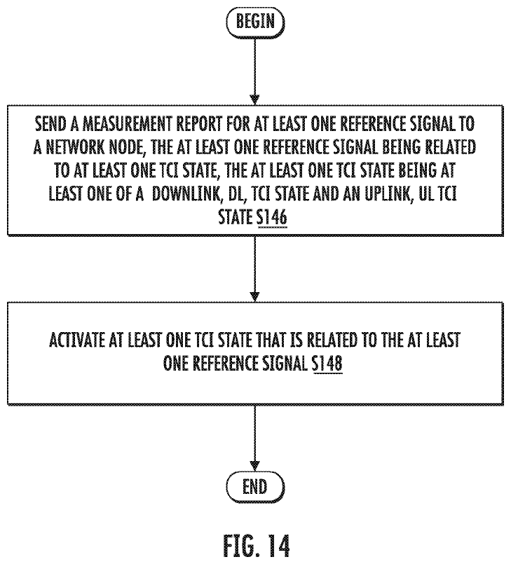

FIG. 14 is a flowchart of an example process in a wireless device 22 according to some embodiments of the present disclosure. One or more blocks described herein may be performed by one or more elements of wireless device 22 such as by one or more of processing circuitry 84, processor 86, radio interface 82 and/or communication interface 60. Wireless device 22 such as via processing circuitry 84 and/or processor 86 and/or radio interface 82 is configured to send a measurement report for at least one reference signal to a network node, the at least one reference signal being related to at least one TCI state, the at least one TCI state being at least one of a downlink, DL, TCI state and an uplink, UL TCI state (Block S146). The process also includes activating at least one TCI state that is related to the at least one reference signal (Block S148).

In some embodiments, a DL TCI state is activated when a beam report includes an DL performance metric. In some embodiments, the DL performance metric includes at least one of DL reference signal received power, RSRP, and DL signal to interference plus noise ratio, SINR. In some embodiments, an UL TCI state is activated when a beam report includes an UL performance metric. In some embodiments, the UL performance metric includes at least one of UL reference signal received power, RSRP, virtual power head room, power head room, DL-RSRP+reduced maximum output power (P-MPR) and P-MPR. In some embodiments, a TCI state is not activated unless the network node sends an acknowledgment, either via Medium Access Control Element, MAC CE, or Downlink Control Information, DCI. In some embodiments, at least one of a list of activated DL TCI states and a list of activated UL TCI states configured for the WD by the network node includes a number, M1, of entries that are reserved for implicit DL TCI state activation. In some embodiments, at least one of a list of activated DL TCI states and a list of activated UL TCI states configured for the WD by the network node includes a number, M2, of entries that are reserved for implicit UL TCI state activation. In some embodiments, at least one of a list of activated DL TCI states and a list of activated UL TCI states configured for the WD by the network node includes a number, M3, of entries that are reserved for implicit DL TCI state activation and UL TCI state activation. In some embodiments, at least one of a list of activated DL TCI states and a list of activated UL TCI states configured for the WD by the network node includes a number, N1, of entries that are reserved for explicit DL TCI state activation. In some embodiments, at least one of a list of activated DL TCI states and a list of activated UL TCI states configured for the WD by the network node includes a number, N2, of entries that are reserved for explicit UL TCI state activation. In some embodiments, at least one of a list of activated DL TCI states and a list of activated UL TCI states configured for the WD by the network node includes a number, N3, of entries that are reserved for explicit DL TCI state activation and explicit UL TCI state activation.

Having described the general process flow of arrangements of the disclosure and having provided examples of hardware and software arrangements for implementing the processes and functions of the disclosure, the sections below provide details and examples of arrangements for separate implicit update of activated transmission configuration indicator (TCI) states for downlink (DL) and uplink (UL).

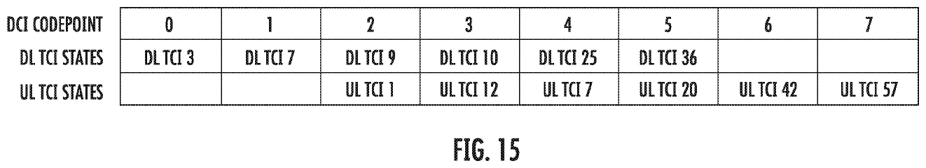

Some embodiments provide separate implicit updates of activated transmission configuration indicator (TCI) states for downlink (DL) and uplink (UL). There are at least two possible implementations when using DCI to select one activated DL TCI state and/or one activated UL TCI state. In a first option, there is a joint list of activated DL TCI states and UL TCI states where both the activated DL TCI states and activated UL TCI states are associated to the same list of DCI codepoints. For example, DCI codepoints of a TCI field in DCI are shown schematically in FIG. 15. In this case, a single codepoint in DCI can be used to update either a DL TCI state (codepoint 0 and 1), or an UL TCI state (codepoint 6 and 7) or both a DL and an UL TCI state (codepoint 2, 3, 4 and 5). For example, when a WD 22 receives a DCI that indicates codepoint 2, the WD 22 may apply DL TCI state 9 for DL signals/channels and UL TCI state 1 for UL signals/channels.

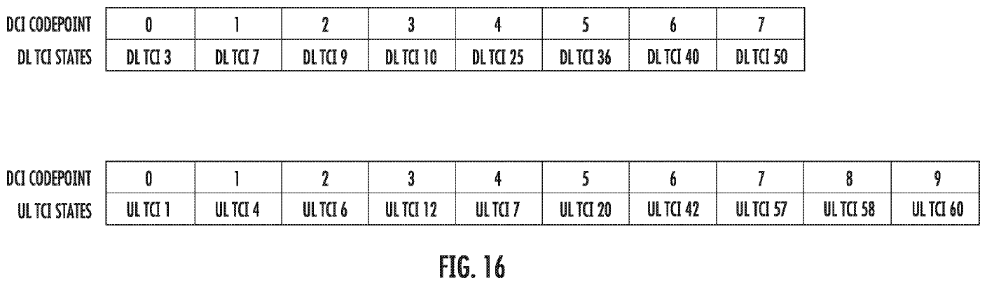

In a second option, two separate lists of activated TCI states are used and each list has its own association to a codepoint, one for DL TCI states and one for UL TCI states, as shown in FIG. 16. In this case, different bitfields in DCI and/or different DCIs may be used to update the DL TCI states and UL TCI states, respectively. For instance, the DCI codepoints corresponding to the DL TCI states may be present in a TCI field of a DL related DCI. For example, DCI formats 1_1/1_2 and the DCI codepoints corresponding to the UL TCI states may be present in a TCI field of an UL related DCI (e.g., DCI formats 0_1/0_2). Alternatively, the DCI codepoints corresponding to the DL TCI states and the DCI codepoints corresponding to the UL TCI states may be present in two TCI fields of the same DCI (i.e., either a DL related DCI or an UL related DCI).

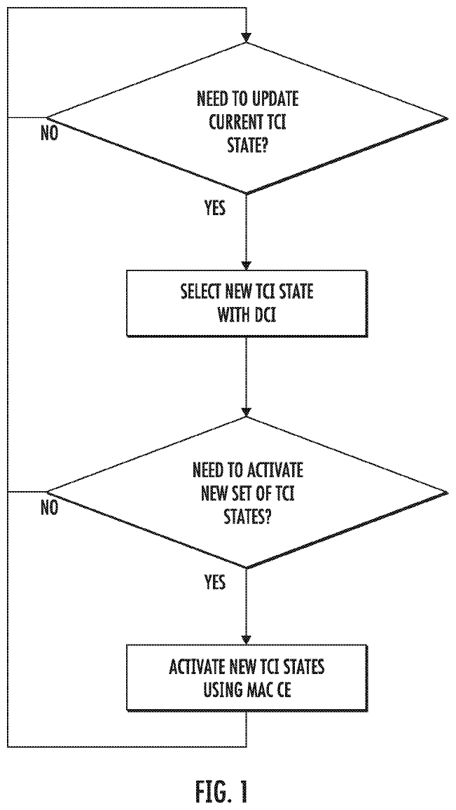

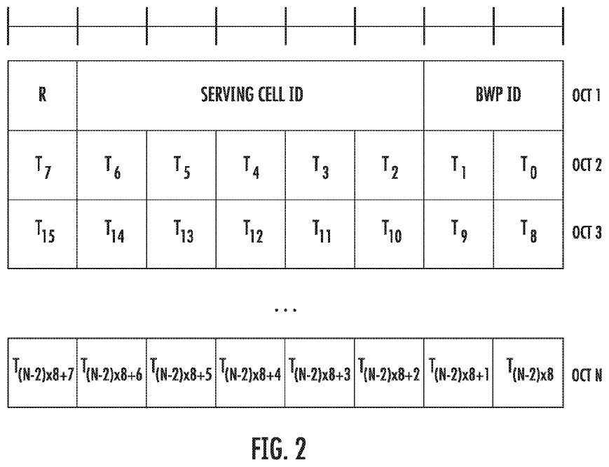

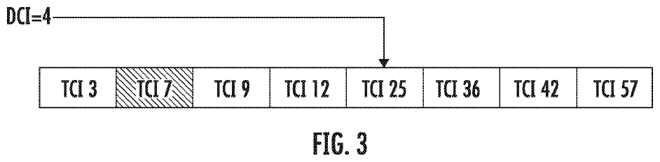

The DL TCI states may typically involve two Types of QCL (as shown in FIG. 1) in FR2, where one QCL type (e.g., QCL Type D) provides the source RS for spatial receive (RX) beam parameters and another QCL type may provide the source RS for other parameters such as Doppler shift, Doppler spread, average delay, and delay spread (e.g., QCL Type A). In contrast, the UL TCI states typically only contain the source RS for the spatial beam with which the WD 22 should transmit UL channels and reference signals. Hence, a WD 22 may be able to support a much larger number of active UL TCI states compared to the number of active DL TCI states. In this embodiment a different number of DCI codepoints may be used for DL TCI states and UL TCI states. In some embodiments, the second option shown in FIG. 16 has an advantage over the first option shown in FIG. 15 because the second option allows different numbers of DCI codepoints for DL TCI states and UL TCI states.

A first set of embodiments are described with reference to the first option described in FIG. 15 (i.e., where a single list of codepoints is associated to DL and/or UL TCI states), and a second set of embodiments are described with reference to the second option described in FIG. 16 (i.e., where separate lists of activated TCI states are used for DL and UL TCI states and each list is associated with its own codepoint). However, it should be noted that some embodiments may apply to both options.

Embodiments Described with Relation to Option 1 In one embodiment, a codepoint is explicitly configured to either implicitly update

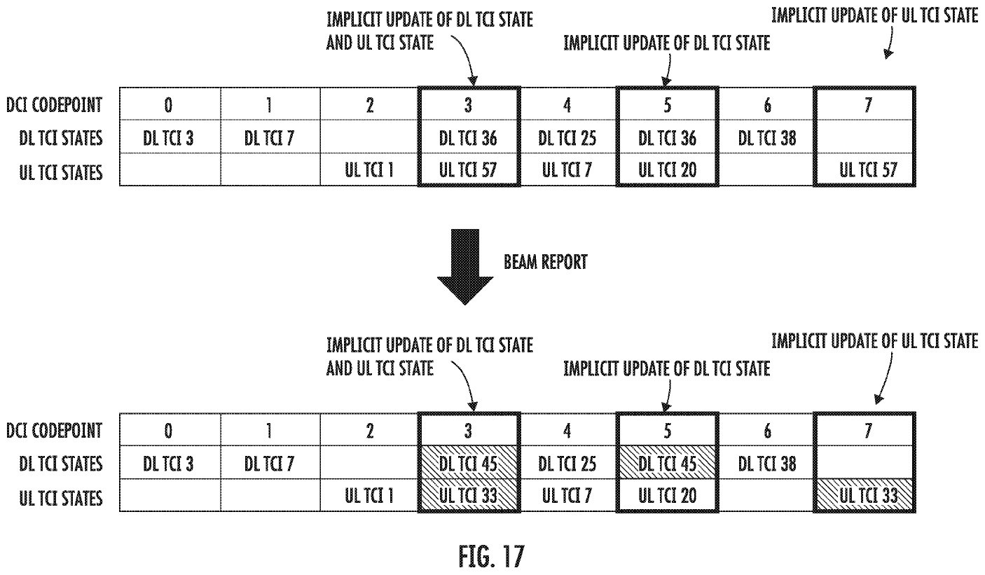

only the DL TCI state, or implicitly update only the UL TCI state or implicitly update both the DL TCI state and UL TCI state based on a beam report. One example of this embodiment is illustrated in FIG. 17. In this example, codepoint 3 is configured to implicitly update both the DL TCI states and UL TCI states based on beam reports, codepoint 5 is configured to implicitly update the DL TCI states based on beam reports and codepoint 7 is configured to implicitly update the UL TCI states based on beam reports.

In 3GPP NR Rel-17 (and/or in later releases), it is expected that a WD 22 can be configured with different types of beam reports where the reported beams are based on only DL performance measurements, only UL performance measurements or both DL and UL performance measurements. Examples of DL performance measurements are DL RSRP and DL SINK. Examples of UL performance measurements are UL RSRP (which is calculated as DL RSRP+available output power including MPE requirements).

In one embodiment, which types of TCI states are updated (DL TCI states and/or UL TCI states) depend on the type of beam report that is used.

In one alternate of this embodiment, a beam report based on DL performance only updates DL TCI states. In the example of FIG. 17, codepoint 5 is configured such that the WD 22 is allowed to implicitly update the DL TCI state associated with codepoint 5. When the WD 22 sends a beam report based on DL performance measurements, then the DL TCI state associated with codepoint 5 is updated implicitly. As shown in FIG. 17, if the beam report includes DL TCI state 45, then the DL TCI state associated with codepoint 5 is updated from ‘DL TCI 36’ to ‘DL TCI 45’. Note that only updating DL TCI states may also be extended to multiple codepoints. In an extension of this embodiment, the WD 22 may be configured with N≥1 codepoints by the network node 16, such that the WD 22 may update N DL TCI states implicitly when N DL beams based on DL performance measurements are reported in a beam report.

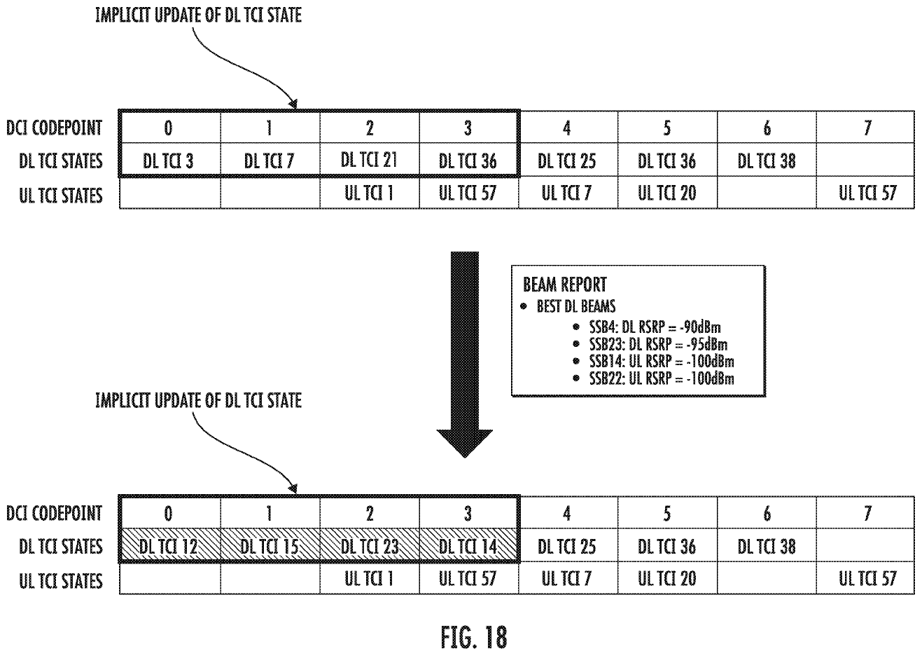

One example of this arrangement is illustrated in FIG. 18. Here the WD 22 has been configured to implicitly update the DL TCI states for codepoint 0 to codepoint 3 and the WD 22 has been configured to report the 4 best beams based on DL performance measurements. As can be seen, the WD 22 updates all four codepoints (0-3) based on the 4 best reported beams in the DL beam report. In this example, the reported beam associated with synchronization signal block (SSB) 4 implicitly activates DL TCI state 12 for Codepoint 0, the reported beam associated with SSB 23 implicitly activates DL TCI state 15 for codepoint 1, the reported beam associated with SSB 14 implicitly activates DL TCI state 23 for codepoint 2 and the reported beam associated with SSB 22 implicitly activates DL TCI state 14 for codepoint 3.

In one alternate of this embodiment, the WD 22 may be configured to report only the best beam based on DL performance or the WD 22 can be configured to report N best beams where N is 1, 2, or 4, for example. Then the DL TCI state is updated for one of the N configured codepoints. If the WD 22 reports 2 best beams based on DL performance, then the DL TCI state may be updated for two of the N codepoints, and so on.

In another alternate of this embodiment, an beam report based on UL performance only updates UL TCI states. In the example of FIG. 17, codepoint 7 is configured such that the WD 22 is allowed to implicitly update the UL TCI state associated with codepoint 7. When the WD 22 sends a beam report based on UL performance measurements, then the UL TCI state associated with codepoint 7 is updated implicitly. As shown in FIG. 17, if the beam report includes UL TCI state 33, then the UL TCI state associated with codepoint 7 is updated from ‘UL TCI 57’ to ‘UL TCI 33’. Note that only updating UL TCI states may also be extended to multiple codepoints. In an extension of this embodiment, the WD 22 may be configured with M≥1 codepoints by the network node such that the WD 22 may update M UL TCI states implicitly when M UL beams based on UL performance measurements are reported in a beam report. This may be done as shown in DL in FIG. 18. In a similar way as described for the DL, in one alternate of this embodiment, if the WD 22 reports only the best beam based on UL performance or reports N best beams where N is 1, 2, or 4), then the UL TCI state is updated for one of the N configured codepoints. If the WD 22 reports 2 best beams based on UL performance, then the UL TCI state is updated for two of the N codepoints, and so on.

In another alternate of this embodiment, a DL performance based beam report updates both DL TCI states and UL TCI states.

In another alternate of this embodiment, a beam report containing best beams with respect to both DL performance and UL performance is used to implicitly update DL TCI states based on reported beams with best DL performance and UL TCI states based on reported beams with best UL performance. In the example of FIG. 17, codepoint 3 is configured such that the WD 22 is allowed to implicitly update both the DL TCI state and UL TCI state associated with codepoint 3. As shown in FIG. 17, if the beam report includes DL TCI state 45 and UL TCI state 33, then the DL TCI state associated with codepoint 3 is updated from ‘DL TCI 36’ to ‘DL TCI 45’, and the UL TCI state associated with codepoint 3 is updated from ‘UL TCI 57’ to ‘UL TCI 33’. In an extension of this embodiment, the WD 22 may be configured with M′≥1 codepoints by the network node such that the WD 22 may update M′ pairs of DL and UL TCI states implicitly when M′ UL beams based on UL performance measurements and M′ DL beams based on DL performance are reported in a beam report.

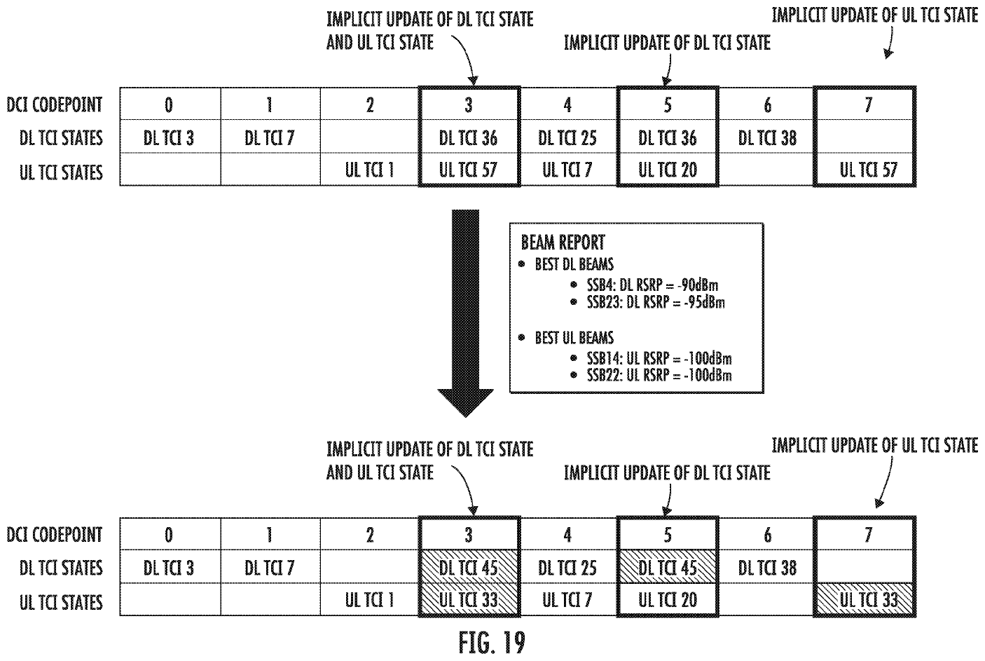

One example of this embodiment is illustrated in FIG. 19, where a beam report that reports the two best DL beams based on DL RSRP and two best UL beams based on UL RSRP is used. The best DL beam is reported as SSB 4 (which may be assumed to be directly or indirectly associated to DL TCI state 45) and hence, the DL TCI states for codepoint 3 and codepoint 5 is implicitly updated with DL TCI state 45. The best UL beam is reported as SSB 4 (which may be assumed to be directly or indirectly associated to UL TCI state 33) and hence, the UL TCI state for codepoint 3 and codepoint 7 is implicitly updated with UL TCI state 33

In one alternate of this embodiment, only the last codepoint is reserved for implicitly updated TCI states, e.g., both DL TCI state and UL TCI state of codepoint 7 is configured to be implicitly updated.

In the above embodiments, only a subset of the codepoints is reserved and/or configured by the network node to the WD 22 to be used for implicit update of DL and/or UL TCI states. In another embodiment, the codepoints that are not reserved and/or configured for implicit update of DL and/or UL TCI states may be used for explicit TCI state indication and/or update. The explicit TCI state indication/update may be based on the three state TCI state indication/update.

Embodiments Described with Relation to Option 2

In one embodiment, a WD 22 may be configured with a first list of N explicitly activated DL TCI states and M implicitly activated DL TCI states and a second list of K explicitly activated UL TCI states and B implicitly activated DL TCI states, where N, M, K and B are integers. In one example, as illustrated in FIGS. 19, N=6, M=1, K=9 and B=1, which means that 7 out of 8 activated DL TCI states should be explicitly updated (using RRC/MAC-CE), while 1 out of 8 activated DL TCI state should be implicitly updated. Also, 9 out of 10 activated UL TCI states should be explicitly updated (using RRC/MAC-CE or via the three state TCI state update), while 1 out of 10 activated UL TCI state should be implicitly updated.

In one embodiment, which list of activated TCI states are updated (the list of activated DL TCI states and/or the list of activated UL TCI states) depends on the type of beam report that is used. In one alternate of this embodiment, a beam report based on DL performance only updates the list of activated DL TCI states. In another alternate of this embodiment, a beam report based on UL performance only updates the list of activated UL TCI states. In another alternate of this embodiment, a beam report based on DL performance updates both the list of activated DL TCI states and the list of activated UL TCI states. In another alternate of this embodiment, a beam report containing best beams with respect to DL performance and UL performance is used to implicitly update the list of activated DL TCI states (based on reported beams with best DL performance) and the list of activated UL TCI states (based on reported beams with best UL performance).

One example of this embodiment is illustrated in FIG. 19. The DL TCI state associated with codepoint 7 in the list of activate DL TCI states and the UL TCI state associated with codepoint 9 in the list of activated UL TCI states is configured to be implicitly updated based on beam reports. In this example, a beam report that reports the two best DL beams based on DL RSRP and two best UL beams based on UL RSRP are used. The best DL beam is reported as SSB 4 (which may be assumed to be directly or indirectly associated to DL TCI state 45) and hence, the DL TCI states for codepoint 7 is implicitly updated with DL TCI state 45. The best UL beam is reported as SSB14 (which may be assumed to be directly or indirectly associated to UL TCI state 33) and hence, the UL TCI state for codepoint 9 is implicitly updated with UL TCI state 33.

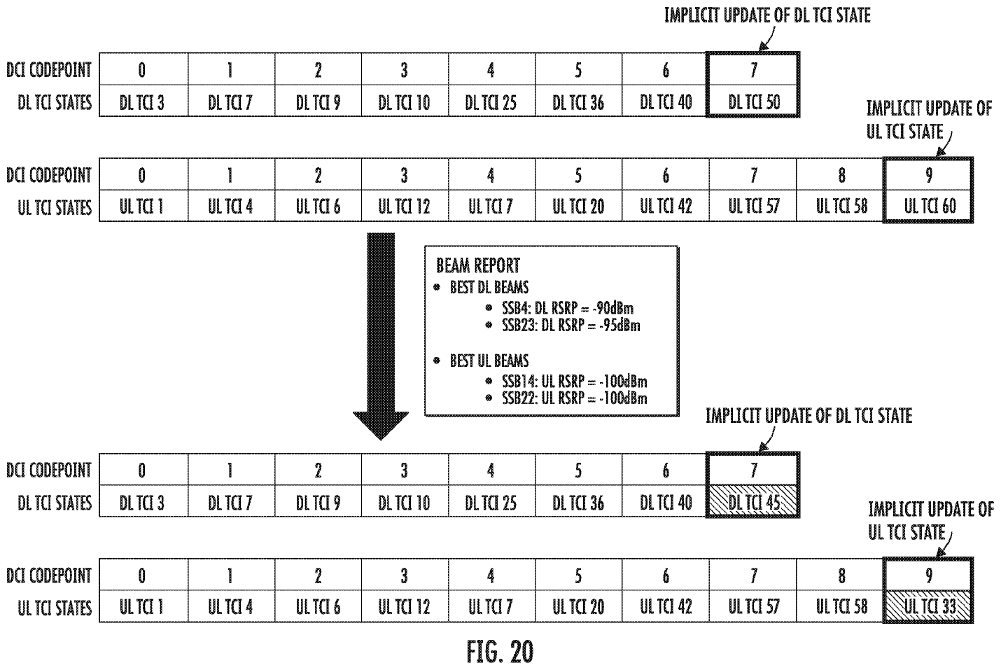

In one embodiment, two or more codepoints are reserved for implicitly activated TCI states in the list of activated DL TCI states and/or the list of activated UL TCI states. In one example, as illustrated in FIG. 20, a WD 22 has been configured with a first list of N=6 explicitly activated DL TCI states and M=2 implicitly activated DL TCI states and a second list of K=7 explicitly activated UL TCI states and B=3 implicitly activated UL TCI states. In this way, for example the last activated TCI state for each list could become associated with codepoint 0, and the previously activated TCI state moves from codepoint 0 to codepoint 1 and so on. This also means that the oldest implicitly updated TCI state is removed or deactivated.

In some embodiments, the last M DCI codepoints of each list of activated TCI states are reserved for implicit update. With this mapping, the explicitly activated TCI states can be activated using state-of-the-art mechanisms, i.e., MAC CE.

When separate beam reports are used for reporting the best DL beams and best UL beams, the best reported beam(s) may be determined based on UL performance (and hence which UL TCI state(s) should be implicitly activated). In some embodiments, the beams in a beam report are expected to be ordered according to performance. For example, if one of the activated UL TCI states should be implicitly activated based on an UL beam report, then the UL TCI state associated with the DL-RS reported as number one in the list of reported DL-RS in the UL beam report may be activated.

When the best DL beams and best UL beams are included in the same report but with two separate lists, then they are distinguishable since, for each of the two list of reported beams, the beams can be expected to be ordered according to performance.

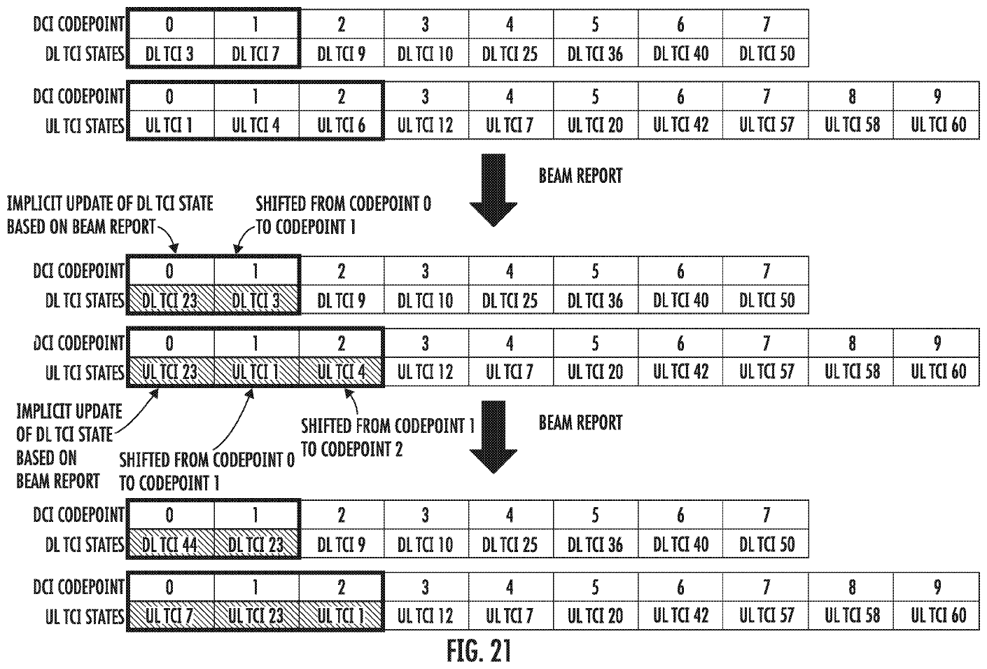

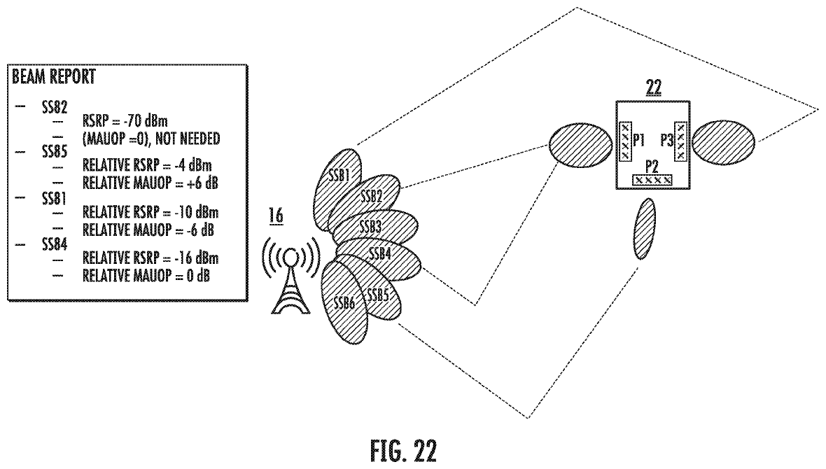

However, when a single report is used, and the list of beams is ordered only based on DL performance, as shown in FIG. 21, then which UL TCI state(s) should be implicitly activated may be specified. In FIG. 21, the absolute values for the best reported beam with respect to DL RSRP and maximum available uplink output power (MAUOP) are signaled for the best beam and relative values are reported for the remaining three reported beams. In this example, the reported beams (or more correctly SSB indices) are ordered according to DL performance (DL RSRP). Hence, which DL TCI state(s) are to be implicitly activated may be determined. This can be done in different ways. In one example, the UL TCI state is updated according to the order determined based on DL performance, which would result in the order SSB2, SSB5, SSB1 and SSB4. In another example the UL TCI is updated according to an order based on UL performance. In FIG. 21, for example, the UL performance can be calculated as RSRP+MAUOP. In this case, the order of best beams for UL performance will be SSB5, SSB2, SSB1, SSB4, and hence, the associated UL TCI state to be implicitly activated may be updated according to that order.

Embodiments Related to Switching the RRC Configuration by MAC CE or DCI

While using MAC CEs is one way to update the RRC configuration, the same principle can be applied by using DCI. In one embodiment, a MAC CE, or DCI switches between RRC configurations configured for Option one discussed above. This switch may use only binary signaling in some implementations. That is, a binary field in a MAC CE or in a DCI may be used to instruct the WD 22 to apply a configuration to either update only DL TCI states or UL TCI states, or to instruct the WD 22 to apply a configuration to update DL TCI states and UL TCI states.

In another embodiment related to the second option discussed above, the MAC CE or DCI selects the N explicitly activated DL TCI states out of greater than N RRC configured options for the first list of TCI states configured for the PDSCH. Further, a same or different MAC CE may have a fixed or optional field to select M implicitly activated DL TCI states out of greater than M configured options. Further, the same or different MAC CE/DCI may have fixed or optional fields to perform the respective selection for the second list of TCI states configured for the PDCCH.

In another embodiment, there is a list of RRC configurations related to either option one or option two and the MAC CE or DCI selects the configuration to be applied at the WD 22. In this case, each configuration option may have an index that is referred to in the respective MAC CE or DCI.

Based on a beam report signaled from the WD 22 to the network node 16, one or more of the activated DL TCI states and/or activated UL TCI states for a WD 22 are implicitly updated. Depending on the report layout, either only an activated DL TCI state is updated, or only an activated UL TCI state is updated or both an activated DL TCI state and an activated UL TCI state are updated.

According to one aspect, a network node 16 configured to communicate with a wireless device (WD 22) is provided. The network node 16 includes a radio interface 62 and/or comprising processing circuitry 68 configured to configure a codepoint to update one or both of a downlink, DL, transmission configuration indicator, TCI, state and an uplink, UL, TCI state based on a beam report.

According to this aspect, in some embodiments, whether to update one or both of DL TCI states and UL TCI states depends on whether the beam report is configured to report one or both of beams having a level of specified DL performance and beams having a level of UL performance. In some embodiments, the network node 16 and/or processing circuitry and/or radio interface are configured to configure the WD 22 to report N best beams based on DL performance and/or UL performance, N being 1, 2 or 4. In some embodiments, the network node 16 and/or processing circuitry 68 and/or radio interface 62 are configured to configure the WD 22 with a first list of N explicitly activated DL or UL TCI states and M implicitly activated DL or UL TCI states, N and M being integers greater than zero. In some embodiments, the network node 16 and/or processing circuitry 68 and/or radio interface 62 are configured to configure the WD 22 with a second list of K explicitly activated DL or UL TCI states and B implicitly activated DL or UL TCI states, K and B being integers greater than zero.

According to another aspect, a method implemented in a network node 16 includes configuring a codepoint to update one or both of a downlink, DL, transmission configuration indicator, TCI, state and an uplink, UL, TCI state based on a beam report.

According to this aspect, in some embodiments, whether to update one or both of DL TCI states and UL TCI states depends on whether the beam report is configured to report one or both of beams having a level of specified DL performance and beams having a level of UL performance. In some embodiments, the method further includes configuring the WD 22 to report N best beams based on DL performance and/or UL performance, N being 1, 2 or 4. In some embodiments, the method further includes configuring the WD 22 with a first list of N explicitly activated DL or UL TCI states and M implicitly activated DL or UL TCI states, N and M being integers greater than zero. In some embodiments, the method further includes configuring the WD 22 with a second list of K explicitly activated DL or UL TCI states and B implicitly activated DL or UL TCI states, K and B being integers greater than zero.

According to yet another aspect, a wireless device, WD 22, configured to communicate with a network node 16 is provided. The WD 22 includes a radio interface 82 and/or processing circuitry 84 configured to transmit a beam report configured to report one or both of beams having a specified level of downlink, DL, performance and beams having a specified level of uplink, UL, performance.

According to this aspect, in some embodiments, the WD 22 and/or processing circuitry 84 and/or radio interface 82 are configured to receive an instruction from the network node 16 as to how to configure the beam report, and configure the beam report according to the received instruction.

According to another aspect, a method in a wireless device, WD 22, transmitting a beam report configured to report one or both of beams having a specified level of downlink, DL, performance and beams having a specified level of uplink, UL, performance.

According to this aspect, in some embodiments, the method further includes: receiving, via the radio interface 82, an instruction from the network node 16 as to how to configure the beam report; and configuring, via the processing circuitry 84, the beam report according to the received instruction.

Some embodiments may include one or more of the following:

Embodiment A1. A network node configured to communicate with a wireless device (WD), the network node configured to, and/or comprising a radio interface and/or comprising processing circuitry configured to:
configure a codepoint to update one or both of a downlink, DL, transmission configuration indicator, TCI, state and an uplink, UL, TCI state based on a beam report.

Embodiment A2. The network node of Embodiment A1, wherein whether to update one or both of DL TCI states and UL TCI states depends on whether the beam report is configured to report one or both of beams having a level of specified DL performance and beams having a level of UL performance.

Embodiment A3. The network node of any of Embodiments A1 and A2, wherein the network node and/or processing circuitry and/or radio interface are configured to configure the WD to report N best beams based on DL performance and/or UL performance, N being 1, 2 or 4.

Embodiment A4. The network node of any of Embodiments A1-A3, wherein the network node and/or processing circuitry and/or radio interface are configured to configure the WD with a first list of N explicitly activated DL or UL TCI states and M implicitly activated DL or UL TCI states, N and M being integers greater than zero.

Embodiment A5. The network node of Embodiment A4, wherein the network node and/or processing circuitry and/or radio interface are configured to configure the WD with a second list of K explicitly activated DL or UL TCI states and B implicitly activated DL or TCI states, K and B being integers greater than zero.

Embodiment B1. A method implemented in a network node, the method comprising:
configuring a codepoint to update one or both of a downlink, DL, transmission configuration indicator, TCI, state and an uplink, UL, TCI state based on a beam report.

Embodiment B2. The method of Embodiment B1, wherein whether to update one or both of DL TCI states and UL TCI states depends on whether the beam report is configured to report one or both of beams having a level of specified DL performance and beams having a level of UL performance.

Embodiment B3. The method of any of Embodiments B1 and B2, further comprising configuring the WD to report N best beams based on DL performance and/or UL performance, N being 1, 2 or 4.

Embodiment B4. The method of any of Embodiments B1-B3, further comprising configuring the WD with a first list of N explicitly activated DL or UL TCI states and M implicitly activated DL or UL TCI states, N and M being integers greater than zero.

Embodiment B5. The method of Embodiment B4, further comprising configuring the WD with a second list of K explicitly activated DL or UL TCI states and B implicitly activated DL or UL TCI states, K and B being integers greater than zero.

Embodiment C1. A wireless device, WD, configured to communicate with a network node, the WD configured to, and/or comprising a radio interface and/or processing circuitry configured to:
transmit a beam report configured to report one or both of beams having a specified level of downlink, DL, performance and beams having a specified level of uplink, UL, performance.

Embodiment C2. The WD of Embodiment C1, wherein the WD and/or processing circuitry and/or radio interface are configured to:

receive an instruction from the network node as to how to configure the beam report; and
configure the beam report according to the received instruction.

Embodiment D1. A method in a wireless device, WD, the method comprising:
transmitting a beam report configured to report one or both of beams having a specified level of downlink, DL, performance and beams having a specified level of uplink, UL, performance.

Embodiment D2. The method of Embodiment D1, further comprising:
receiving an instruction from the network node as to how to configure the beam report; and
configuring the beam report according to the received instruction.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
a radio interface configured to:
receive a beam report from the WD, the beam report including at least one indication of a transmission configuration indicator, TCI, state, an indication indicating one of:
a downlink, DL, TCI state;
an uplink, UL TCI state; and
both the DL TCI state and the UL TCI state; and
processing circuitry in communication with the radio interface, the processing circuitry configured to:
configure at least one codepoint based at least in part on at least one of the at least one indication included in the beam report, each codepoint configured to implicitly indicate one of:
the updated DL TCI state;
the updated UL TCI state; and
both the updated DL TCI state and the updated UL TCI state; and
the radio interface being further configured to transmit the at least one codepoint to the WD.

2. The network node of claim 1, wherein only an updated DL TCI state is indicated by at least one of the at least one codepoint based on an indication of DL performance.

3. The network node of claim 1, wherein only an updated UL TCI state is indicated by at least one of the at least one codepoint based on an indication of UL performance.

4. The network node of claim 1, wherein a first codepoint is configured for DL TCI states and a second codepoint is configured for UL TCI states.

5. The network node of claim 1, wherein each of a plurality of codepoints are configured to implicitly indicate a different one of a set of at least one of DL TCI states and UL TCI states.

6. The network node of claim 1, wherein each of the at least one codepoint is configured by one of a medium access control, MAC, control element, CE, and downlink control information, DCI.

7. A method in a network node configured to communicate with a wireless device, WD, the method comprising:
receiving a beam report from the WD, the beam report including at least one indication of a transmission configuration indicator, TCI, state, an indication indicating one of:
a downlink, DL, TCI state;
an uplink, UL TCI state; and
both the DL TCI state and the UL TCI state; and
configuring at least one codepoint based at least in part on at least one of the at least one indication included in the beam report, each codepoint configured to implicitly indicate one of:
the updated DL TCI state;
the updated UL TCI state; and
both the updated DL TCI state and the updated UL TCI state; and
transmitting the at least one codepoint to the WD.

8. The method of claim 7, wherein only an updated DL TCI state is indicated by at least one of the at least one codepoint based on an indication of DL performance.

9. The method of claim 7, wherein only an updated UL TCI state is indicated by at least one of the at least one codepoint based on an indication of UL performance.

10. The method of claim 7, wherein a first codepoint is configured for DL TCI states and a second codepoint is configured for UL TCI states.

11. The method of claim 7, wherein each of a plurality of codepoints are configured to implicitly indicate a different one of a set of at least one of DL TCI states and UL TCI states.

12. The method of claim 7, wherein each of the at least one codepoint for a plurality of TCI states are configured by one of a medium access control, MAC, control element, CE, and downlink control information, DCI.

13. A wireless device, WD, configured to communicate with a network node, the WD comprising:
a radio interface configured to transmit a beam report to the network node, the beam report including at least one codepoint indicating a transmission configuration indicator, TCI, state for at least one of:
a downlink, DL, beam;
an uplink, UL, beam; and
both the DL beam and the UL beam.

14. The WD of claim 13, wherein the TCI state for a DL beam is indicated based on a DL performance measurement but not an UL performance measurement.

15. The WD of claim 13, wherein the TCI state for an UL beam is indicated based on an UL performance measurement but not a DL performance measurement.

16. The WD of claim 13, wherein a first codepoint indicates a TCI state for a DL beam and a second codepoint indicates a TCI state for an uplink beam.

17. The WD of claim 13, wherein the at least one codepoint indicates a TCI state for one of a DL beam determined to provide a best DL performance of a plurality of DL beams and an UL beam determined to provide a best UL performance of a plurality of UL beams.

18. The WD of claim 13, wherein a subset of a plurality of codepoints are configured for implicit indication of TCI states.

19. The WD of claim 13, wherein the beam report further includes a list of a plurality of beams in order of highest performance to lowest performance.

20. A method in a wireless device, WD, configured to communicate with a network node, the method comprising:
transmitting a beam report to the network node, the beam report including at least one codepoint indicating a transmission configuration indicator, TCI, state for at least one of:
a downlink, DL, beam;
an uplink, UL, beam; and
both the DL beam and the UL beam.

21.-50. (canceled)
